(19) United States
(12) Patent Application Publication
(10) Pub. No.: US 2009/0004940 A1
(43) Pub. Date: Jan. 1, 2009

(54) Textile Complex Comprising a Combining Substrate Coated on Its Two Sides

(76) Inventors: Jean Lefebre, Estrees Mons (FR); Vincent Festino, Gricourt (FR)

Correspondence Address: BACHMAN & LAPOINTE, P.C., 900 CHAPEL STREET, SUITE 1201, NEW HAVEN, CT, 06510, US

(21) Appl. No.: 11/792,119

(22) PCT Filed: Dec. 6, 2005
(86) PCT No.: PCT/FR2005/003057

§ 371 Date: Jul. 17, 2008

(30) Foreign Application Priority Data
Dec. 9, 2004 (FR) 0413141

(51) Int. Cl. D03D 9/00; B32B 7/12; B32B 27/04; B32B 37/12

(52) U.S. Cl. 442/304; 428/347; 442/1; 428/340; 156/235

(57) ABSTRACT

A textile complex includes a first textile layer, a second textile layer and a substrate for bonding the textile layers together, wherein the substrate includes a third textile layer, each of the faces of which are coated with a thermo-adhesive product network, and the substrate is inserted between the first and second textile layers so as to bond, by respectively laminating a face of the textile layers to a thermo-adhesive product network, the first and second textile layers together.

### BACKGROUND

(1) Field of the Invention

The invention relates to a textile complex including two textile layers bonded by means of a substrate, such a bonding substrate, a method for producing such a substrate, a method for complexing a complex according to the invention and a clothing article including at least one part cut out of such a complex.

(2) Prior Art

It typically applies to textile complexes intended for producing clothing articles such as lingerie articles or athletic wear.

To produce these articles, but also in numerous other end applications, it is often necessary to bond two textile layers together so as in particular to combine their respective properties (appearance, comfort, volume, stability, etc.).

To do this, it is known to provide one of the faces of at least one of the textile layers with a thermo-adhesive product network so as to ensure, by lamination, the desired bonding.

However, some textile layers, in particular those used in lingerie applications or athletic wear, cannot be satisfactorily coated with a thermo-adhesive product network. In particular, such an incapacity may be due to the structure of the textile layer itself (excessively openwork structure, inadequate basis weight, etc.) or to poor performance of the textile layer during coating operations (tension, heat, poor performance of dyes, etc.).

To attempt to resolve this problem, it has been proposed to use a film or a grid of thermo-adhesive product, which is inserted between the two textile layers so as to ensure their bonding.

This solution, while making it possible to eliminate the coating of textile layers, has in particular the disadvantage of causing negative characteristics for the complex formed by the two layers. In particular, the following are observed:
stiffening of the complex, which adversely affects its hand;
reduced breathability of the complex, which adversely affects its comfort;
yellowing of the complex over time, which is not aesthetically satisfactory.

### SUMMARY OF THE INVENTION

The invention aims in particular to solve the problems mentioned above by proposing in particular a textile complex in which the two textile strains are bonded by a textile substrate of which the two faces are coated with a thermo-adhesive product network so as to benefit from the advantages of the lamination between textile layers, regardless of the nature of the textile layers to be bonded.

To this end, according to a first aspect, the invention proposes a textile complex including a first textile layer, a second textile layer and a substrate for bonding said textile layers together, wherein said substrate includes a third textile layer, each of the faces of which are coated with a thermo-adhesive product network, and said substrate is inserted between the first and second textile layers so as to bond, by respectively laminating a face of said textile layers to a thermo-adhesive product network, the first and second textile layers together.

According to a second aspect, the invention relates to a bonding substrate for such a textile complex, wherein said substrate includes a textile layer, each of the faces of which is coated with a thermo-adhesive product network.

According to a third aspect, the invention relates to a method for producing such a bonding substrate, which method includes steps consisting of:

i) forming the textile layer;

ii) depositing a thermo-adhesive product network on a transfer support;

iii) heating said network on the support at a temperature above the product melting point;

iv) placing said transfer support with the heated network opposite a face of the textile layer so as to put the network in contact with said face, the respective affinities of the support and the textile layer for the product being such that the network is transferred from the support to the face of the textile layer, without specific heating of said textile layer;

v) executing steps ii) to iv) a second time so as to coat the other face of the textile layer with another thermo-adhesive product network.

According to a fourth aspect, the invention relates to a method for complexing a textile complex according to the invention, in which a bonding substrate according to the invention is inserted between the first and second textile layers, wherein the stacking thus formed is then placed in a lamination machine so as to bond, by applying pressure and heat, the first and second textile layers together.

According to a fifth aspect, the invention relates to a clothing article, in particular a lingerie article or athletic wear, wherein said article includes at least one part cut out of a textile complex according to the invention.

### DETAILED DESCRIPTION OF THE PREFERRED EMBODIMENTS

The invention can be better understood from the following description of various embodiments.

The textile complex according to the invention includes a first and a second textile layer bonded together. The textile layers can be of any type, in particular those used to produce lingerie articles or athletic wear.

In a specific embodiment, at least one of the first and second textile layers has an openwork structure on which it is not possible to reliably coat a thermo-adhesive product network. By an openwork structure, we mean that the covering power of the layer is low, i.e. it has openwork areas. Such openwork structures are obtained, for example, with a weave in which the threads are spaced apart widely and/or with threads having a small diameter and/or with layers having a low basis weight (for example between 20 g/m² and 200 g/m²). In specific examples, the textile layer with an openwork structure is formed by a knit, lace or bobbinet.

In any case, the implementation of the invention is also advantageous for other types of textile layers, for example, non-woven, woven or knit, in particular when the textile layer is not suitable for receiving a coating of thermo-adhesive product, in particular if the coating would significantly pass through the textile layer.

To produce textile layers, it is possible to use threads based on natural materials such as cotton or based on synthetic materials such as polyamide, polyester or polypropylene. The threads used can also have specific mechanical properties such as elasticity or responsiveness, for example the threads can be based on elastane. In addition, threads of different types can be used in the same textile layer so as to combine their specific characteristics.

To bond the first and second textile layers, the invention involves the use of a bonding substrate, which is inserted between said textile layers so as to ensure their bonding. To do this, the substrate includes a third textile layer, each of the faces of which is coated with a thermo-adhesive product network. Thus, the bonding of the first and second textile layers is performed by laminating respectively one face of said textile layers on a thermo-adhesive product network. The complex obtained is therefore formed by a stack of textile layers, which makes it possible to preserve a satisfactory hand.

The textile layer can be of any known type, identical or not to one of the first or second textile layers to be bonded. According to an embodiment, the textile layer of the substrate is formed by a knit, possibly blocked.

Particularly in the last case, the use of the bonding substrate makes it possible, in addition to the bonding aspect, to structure the complex by blocking and/or by reinforcing certain portions of it. In another embodiment, the bonding substrate can be arranged to allow the initial textile characteristics of the first and second textile layers to be preserved, in particular in terms of elasticity and feel.

According to an embodiment, the textile layer of the bonding substrate has a low basis weight, for example between 10 g/m² and 50 g/m², so as to obtain a relatively lightweight textile complex as is desirable particularly in the specific applications envisaged.

As regards the thermo-adhesive product network, it may be possible for the product of the two networks to be the same, for example based on a thermofusible copolyamide. In addition, each network can be made in the form of points of product distributed regularly over the face of the textile layer so as to combine adhesion and breathability of the complex, in particular with regard to air and water vapour. Alternatively, the thermo-adhesive product network can be made in the form of other types of non-continuous individualised areas, in particular in the form of lines or other two-dimensional patterns.

The complex according to the invention is particularly intended to be but so as to form at least one part of a clothing article, in particular a lingerie article or athletic wear.

Below, a method for producing a bonding substrate according to the invention is described, in which the textile layer is first formed conventionally by techniques for weaving, knitting or producing a non-woven fabric.

Then, the invention involves coating the faces of the textile layer by means of a coating method in which the textile layer is not specifically heated, so as to preserve the main properties of said layer.

To this end, the thermo-adhesive product network is deposited on a transfer support, then said network on the support is heated to a temperature above the melting point of the product. In particular, the deposition of the thermo-adhesive product on the support can be performed by serigraphy or by heliography.

In general, the heating temperature is between 90° C. and 215° C., which allows for the melting and drying of most of the thermo-adhesive products used to coat textile layers. In one embodiment, the thermo-adhesive product is based on a copolymer such as copolyamide and/or copolyester and/or other thermoplastic or thermosetting copolymers. The thermo-adhesive product can be provided in an aqueous and/or alcohol and/or other polar solvent dispersion, and be at room temperature in the form of a paste.

Then, the transfer support with the heated network is placed opposite the face of the textile layer to be coated so as to place the network in contact with said face. Thus, by adjusting the respective affinities of said support and said textile layer, it is possible to allow for the transfer of the network from the transfer support to the face of the textile layer. The transfer can be performed on the entire face of the textile layer or on just a predefined portion thereof.

According to an embodiment described in document EP-A-0 219 378, the transfer support is formed by an endless strip, of which the face is, for example, coated with a substance that adheres poorly to the thermo-adhesive product, for example based on polytetrafluoroethylene or silicone. The strip is moved by continuous scrolling from an upstream area in which the network is placed on the strip, to a convergence area in which the contact is carried out. Thus, the network can be heated during the movement between the upstream area and the convergence area, for example by being placed in an oven or by exposure to radiation (infrared or microwave) or to a hot air jet, so as to ensure the drying and melting of the thermo-adhesive product.

In this embodiment, it is possible to move jointly move the textile layer and the transfer support so as to perform the coating continuously over a length of textile layer.

In the coating method used, it is also possible for the dimension of the convergence area to be arranged so as to enable the transfer to be performed by applying a crushing force of the network onto the face of the textile layer, said force being applied so as to allow the network to be bonded to said face without any significant penetration of the product into the textile layer. In particular, the distance between the textile layer and the support can be substantially equal to the height of the network. Thus, as the transfer is carried out by contact and not by pressing, the textile layer is not excessively impregnated with the thermo-adhesive product, which prevents the product from passing through the textile layer and therefore enables a satisfactory hand to be preserved for said coated textile layer, while ensuring satisfactory adhesion.

Alternatively, it is also possible, after the transfer of the network to the textile layer, to cool said layer, for example by blowing air, so as to ensure a faster solidification of the product than by natural convection. Thus, the time of contact between the heated product and the textile layer can be reduced, thereby limiting the possible damage of the textile layer that could result from said contact.

The invention uses a coating method similar to that described above so as to coat the other face of the textile layer with another thermo-adhesive product network. According to an embodiment, the two coatings are performed successively by running the textile layer through the coating installation twice. According to another embodiment, at least some steps of the two coatings, in particular the cooling, can be performed substantially simultaneously.

To perform the double coating continuously, the textile layer can be wound around an upstream bobbin, continuously unwound, coated on its two faces, and rewound on a downstream bobbin.

The use of a coating method as described above makes it possible to coat networks with a low basis weight (for example between 5 g/m² and 200 g/m²), and to obtain thermo-adhesive product networks that, after lamination on the textile layers, are almost invisible, so as to prevent a marked appearance on the faces of the complex.

The invention also proposes a method for complexing a textile complex according to the invention in which the bonding substrate is inserted between the first and second textile layers, and the stack thus formed is then placed in a lamination machine so as to bond, by applying pressure and heat, the first and second textile layers together.

Below, an embodiment of a textile complex according to the invention is described, as a non-limiting illustration.

### Bonding Substrate:

Textile layer: bi-stretch polyamide base
Basis weight: 20 g/m²
Coating: thermofusible copolyamide (melting point 120° C.); basis weight point network 8 g/m² per face

### First Textile Layer:

Polyamide/elastane base (80%/20%)

### Second Textile Layer:

Polyamide/elastane base (85%/15%)
Basis weight: 115 g/m²
The complexing is performed at 130° C. on a continuous lamination press.

1-20. (canceled)

21. Textile complex including a first textile layer, a second textile layer and a substrate for bonding said textile layers together, wherein said substrate includes a third textile layer having a plurality of faces, each of the faces of which are coated with a thermo-adhesive product network, and said substrate is inserted between the first and second textile layers so as to bond, by respectively laminating a respective face of said first and second textile layers to said thermo-adhesive product network to join the first and second textile layers together.

22. Textile complex according to claim 21, wherein in that at least one of the first and second textile layers has an openwork structure.

23. Textile complex according to claim 22, wherein each textile layer with an openwork structure is formed by a knit, lace or bobbinet.

24. Bonding substrate for a textile complex including a first textile layer and a second textile layer which includes a third textile layer, each of the faces of the third textile layer being coated with a thermo-adhesive product network.

25. Bonding substrate according to claim 24, wherein the third textile layer is formed by a knit.

26. Bonding substrate according to claim 25, wherein said knit is blocked.

27. Bonding substrate according to claim 24, wherein the third textile layer has a basis weight of between 10 g/m² and 50 g/m².

28. Bonding substrate according to claim 24, wherein the thermo-adhesive product network on the faces is the same and is based on thermofusible copolyamide.

29. Bonding substrate according to claim 24, wherein each said network is in the form of points of product distributed regularly over a respective face of the third textile layer.

30. A method for producing a bonding substrate, which method includes the steps of:
i) forming a textile layer;
ii) depositing a thermo-adhesive product network on a transfer support;
iii) heating said network on the transfer support at a temperature above the product melting point;
iv) placing said transfer support with the heated network opposite a face of the textile layer so as to place the network in contact with said face, the respective affinities of the transfer support and the textile layer for the product being such that the network is transferred from the transfer support to the face of the textile layer, without specific heating of said textile layer; and
v) executing steps ii) to iv) a second time so as to coat another face of the textile layer with another thermo-adhesive product network.

31. Method of production according to claim 30, further comprising carrying out the two coatings successively.

32. Method of production according to claim 30, further comprising carrying out substantially simultaneously at least some steps of the two coatings.

33. Method of production according to claim 30, further comprising placing the network in contact with one of the faces of the textile layer by moving the textile layer and/or the transfer support toward a convergence area.

34. Method of production according to claim 33, wherein said moving step comprises moving the network over the one face of the textile layer in an area upstream of the convergence area, and the heating of the product takes place during the movement between said areas.

35. Method of production according to claim 34, further comprising forming the transfer support by a strip, and carrying out the movement by continuous scrolling from the upstream area to the convergence area.

36. Method of production according to claim 33, wherein said moving step comprises moving the textile layer and the transfer support jointly so as to perform the coating continuously over a length of the textile layer.

37. Method of production according to claim 33, further comprising arranging a dimension of the convergence area so as to enable the transfer to be performed by applying a crushing force of the network onto the one face of the textile layer, and applying said force so as to allow the network to be bonded to said face without any significant penetration of the product into the textile layer.

38. Method of production according to claim 30, further comprising heating the transfer support to a temperature between 90° C. and 215° C.

39. Method of production according to claim 30, further comprising after the transfer of a network, cooling the textile layer so as to ensure the solidification of the product of said network.

40. Method for complexing a textile complex comprising the steps of inserting a bonding substrate according to claim 24 between first and second textile layers, and a stack thus formed is then placed in a lamination machine so as to bond, by applying pressure and heat, the first and second textile layers together.

41. Clothing article which includes at least one part cut out of a textile complex according to claim 21.

42. Clothing article according to claim 41, wherein said clothing article is a lingerie article.

43. Clothing article according to claim 41, wherein said clothing article is athletic wear.
